(19) United States
(12) Patent Application Publication
(10) Pub. No.: US 2016/0110221 A1
(43) Pub. Date: Apr. 21, 2016

(54) SCHEDULING SYSTEM, SCHEDULING METHOD, AND RECORDING MEDIUM

(71) Applicant: NEC CORPORATION, Tokyo (JP)

(72) Inventor: Takeo HOSOMI, Tokyo (JP)

(21) Appl. No.: 14/787,813

(22) PCT Filed: Mar. 18, 2014
(86) PCT No.: PCT/JP2014/001557

§ 371 Date: Oct. 29, 2015

(30) Foreign Application Priority Data
May 22, 2013 (JP) 2013-107578

(51) Int. Cl. G06F 9/50

(52) U.S. Cl. CPC G06F 9/5005

(57) ABSTRACT

Provided are a scheduling system, etc., such that it is possible to efficiently utilize processing performance of a resource. A scheduling system comprises a scheduler which determines specific resources for processing a task to be processed at a computation processing device which includes a many-core accelerator as resources and a processor which controls the resources, said scheduler determining the specific resources according to a first instruction for reserving resources, which is included in the task.

### TECHNICAL FIELD

The present invention relates to a scheduling system, etc. that perform scheduling.

### BACKGROUND ART

A space division method is a scheduling method used in a multiprocessor system when a plurality of independent tasks is processed. Referring to FIG. 17, a configuration in a system 54 that adopts a space division method will be described. FIG. 17 is a block diagram illustrating a configuration of a computer system (calculation processing system, information processing system, hereinafter also simply referred to as “system”) that adopts a space division method as a related technology.

Referring to FIG. 17, the system 54 includes a server 40, a task scheduler 45, and a server resource management unit 46. The server 40 includes a processor 41, a processor 42, a processor 43, a processor 44, etc.

The task scheduler 45 receives a task to be executed as an input. Then, the task scheduler 45 reserves, by referencing the number of processors required for executing the received task and information about usage status of a plurality of processors (the processors 41 to 44) held by the server resource management unit 46, a processor (or processors) required for the execution. Then, the task scheduler 45 updates information held by the server resource management unit 46 and puts the task to the server 40. The task scheduler 45 updates the information held by the server resource management unit 46 after detecting completion of task execution by the server 40. The task scheduler 45 releases the processor reserved for processing the task.

The task scheduler 45 uses the processors (the processors 41 to 44) included in the server 40 for processing a plurality of tasks in accordance with the aforementioned operation. Thus, processing performance in the server 40 improves.

On the other hand, as illustrated in FIG. 18, a server including a configuration different from the aforementioned configuration also exists. FIG. 18 is a block diagram illustrating a configuration of a system including a many-core accelerator as a related technology. Referring to FIG. 18, a server 47 includes a host processor 48 and a main storage apparatus (main memory, memory, hereinafter referred to as “main memory”) 50 accessed by the host processor 48. Further, the server 47 includes a many-core accelerator (also referred to as “multi-core accelerator” or “multiple core accelerator”) 49. Furthermore, the server 47 includes an accelerator memory 51 accessed by the many-core accelerator 49.

Referring to FIG. 19, a configuration included in a system in which the server 47 including such a configuration as described above adopts such a task scheduling technology as described above will be described. FIG. 19 is a block diagram illustrating a configuration of a task scheduler for a system including a many-core accelerator as a technology related to the present invention. Referring to FIG. 19, a system 55 includes a task scheduler 52, a server resource management unit 53, and a server 47.

FIG. 20 illustrates processes when a server including a many-core accelerator illustrated in FIG. 18 adopts such a task scheduling method as described above. FIG. 20 is a flowchart (sequence diagram) illustrating a flow of processes in a task scheduler as a related technology.

Referring to FIGS. 19 and 20, the task scheduler 52 receives a task to be executed as an input, and references information about usage status of resource managed by the server resource management unit 53 in resource information related to the host processor 48 and the many-core accelerator 49, required for executing the task. Then, the task scheduler 52 reserves a resource required for processing the task by referencing information about usage status of a resource managed by the server resource management unit 53 (Step S40). Then, the task scheduler 52 puts the task to the server 47 by specifying the reserved resource (Step S41). The task scheduler 52 transmits a signal indicating completion of the task to the server resource management unit 53 and releases the resource reserved for processing the task (Step S42) when detecting the completion of task processing by the server 47.

Referring to FIG. 21, processes performed by the server 47 for execution of one task will be described. FIG. 21 is a flowchart illustrating a flow of processes in a system including a many-core accelerator related to the present invention.

Referring to FIGS. 19 and 21, the server 47 receives a task put by the task scheduler 52 and starts processing of the task on the host processor 48 (Step S43). Then, the host processor 48 transmits data to be processed in the many-core accelerator 49 from the main memory 50 to the accelerator memory 51 (Step S44). The many-core accelerator 49 processes data transmitted by the host processor 48 (Step S45). Then, the host processor 48 transmits a result of processing by the many-core accelerator 49 from the accelerator memory 51 to the main memory 50 (Step S46). Then, the host processor 48 processes a next task (Step S43 or S44). The server 47 completes task processing in the host processor 48 by repeating the processes in Steps S43 to S46 at least once. The server 47 notifies completion of processing of the task to the task scheduler 52 (Step S47).

A program execution control method disclosed in PTL 1 represents a method for power-saving control in a system including different types of processors. In other words, the program execution control method is a control method for performance improvement. In accordance with the execution control method, a clock frequency is changed so that respective processors complete split tasks simultaneously.

A data processing apparatus disclosed in PTL 2 reduces overhead required for saving and restoration, depending on progress status of the interrupted process when interrupting a process in data processing to give priority to another process.

In a data processing apparatus disclosed by PTL 3, software executed on a processor and hardware dedicated to a specific process are carried out in order of priority. The data processing apparatus enhances processing efficiency related to task switching.

### CITATION LIST

### Patent Literature

[PTL 1] Japanese Laid-open Patent Application No. 2011-197803

[PTL 2] Japanese Laid-open Patent Application No. 2010-181989

[PTL 3] Japanese Laid-open Patent Application No. 2007-102399

### SUMMARY OF INVENTION

### Technical Problem

Referring to FIGS. 19 and 21, a problem that occurs when a server 47 including a many-core accelerator 49 adopts such a task scheduling system as described above will be described.

A task scheduler 52 allocates a task to a resource by managing a resource in the many-core accelerator 49 when putting a task to the server 47. The task scheduler 52 releases the allocated resource when completing the task. In FIG. 19, the task scheduler 52 reserves a resource in the many-core accelerator 49 when putting a task to the server 47. The task scheduler 52 continues reserving the resource until completing the task. Therefore, the task scheduler 52 continues reserving the resource while the host processor 48 executes processing of a task in Step S43 or S47. Further, the task scheduler 52 continues reserving the resource while the host processor 48 transmits data between a main memory 50 and an accelerator memory 51 in Steps S44, S46, etc.

Further, the task scheduler 52 reserves a maximum resource for processing the series of tasks on task activation even if a resource of the many-core accelerator 49 required for processing a series of tasks changes. Therefore, when a specific task using just part of a resource is processed in the series of tasks, there is a redundant resource that does not perform a process in Step S45.

A problem that, as described above, there is a redundant resource that does not perform a specific process when a series of tasks are processed is referred to as an unused resource problem.

On the other hand, there exists a method in which, in order to avoid the aforementioned unused resource problem, the task scheduler 52 recognizes that the many-core accelerator 49 holds a more resource than the actual resource. However, as a result of avoiding the unused resource problem by such a method as described above, a resource of the many-core accelerator 49 becomes insufficient for actually processing a task. Therefore, the many-core accelerator 49 fails to process the task, or task processing becomes an excessively heavy load in the many-core accelerator 49. Consequently, processing performance possessed by a system 55 degrades.

In other words, a task scheduler 52 that adopts such a processing method as described above is not able to avoid the unused resource problem. Therefore, the many-core accelerator 49 degrades processing performance or fails task processing.

A main objective of the present invention is to provide a scheduling system, etc. more efficiently enabling processing performance possessed by a resource to be exhibited.

### Solution to Problem

In order to achieve the object mentioned above, a scheduling system includes the following configuration.

In other word, a scheduling system including:

a scheduler configured to determine a specific resource that processes a task in accordance with a first instruction to be included in the task processed by a calculation processing apparatus, which includes a many-core accelerator being resource and a processor controlling the resource, and to reserve the resource.

Also, as another aspect of the present invention, a scheduling method includes:

determining a specific resource that processes a task in accordance with a first instruction to be included in the task processed by a calculation processing apparatus, which includes a many-core accelerator being resource and a processor controlling the resource, and reserving the resource.

### Advantageous Effects of Invention

A scheduling system, etc. according to the present invention is capable of more efficiently enabling processing performance possessed by a resource to be exhibited.

### BRIEF DESCRIPTION OF THE DRAWINGS

FIG. 1 is a block diagram illustrating a configuration of a scheduling system according to a first exemplary embodiment of the present invention.

FIG. 2 is a sequence diagram illustrating a flow of processes in the scheduling system according to the first exemplary embodiment.

FIG. 3 is a block diagram illustrating a configuration of a scheduling system according to a second exemplary embodiment of the present invention.

FIG. 4 is a sequence diagram illustrating a flow of processes in the scheduling system according to the second exemplary embodiment.

FIG. 5 is a block diagram illustrating a configuration of a scheduling system according to a third exemplary embodiment of the present invention.

FIG. 6 is a sequence diagram illustrating a flow of processes in the scheduling system according to the third exemplary embodiment.

FIG. 7 is a block diagram illustrating a configuration of a scheduling system according to a fourth exemplary embodiment of the present invention.

FIG. 8 is a sequence diagram illustrating a flow of processes in the scheduling system according to the fourth exemplary embodiment.

FIG. 9 is a sequence diagram illustrating a second flow of processes in the scheduling system according to the fourth exemplary embodiment.

FIG. 10 is a block diagram illustrating a configuration of a scheduling system according to a fifth exemplary embodiment of the present invention.

FIG. 11 is a sequence diagram illustrating a flow of processes in the scheduling system according to the fifth exemplary embodiment.

FIG. 12 is a block diagram illustrating a configuration of a scheduling system according to a sixth exemplary embodiment of the present invention.

FIG. 13 is a flowchart illustrating a flow of processes in the scheduling system according to the sixth exemplary embodiment.

FIG. 14 is a block diagram illustrating a configuration of a scheduling system according to a seventh exemplary embodiment of the present invention.

FIG. 15 is a sequence diagram illustrating a flow of processes in the scheduling system according to the seventh exemplary embodiment.

FIG. 16 is a schematic block diagram illustrating a hardware configuration of a calculation processing apparatus capable of realizing a scheduling system according to each exemplary embodiment of the present invention.

FIG. 17 is a block diagram illustrating a configuration of a system adopting a space division method related to the present invention.

FIG. 18 is a block diagram illustrating a configuration of a system including a many-core accelerator related to the present invention.

FIG. 19 is a block diagram illustrating a configuration of a task scheduler for a system including a many-core accelerator related to the present invention.

FIG. 20 is a flowchart illustrating a flow of processes in a task scheduler related to the present invention.

FIG. 21 is a flowchart illustrating a flow of processes in a system including a many-core accelerator related to the present invention.

FIG. 22 is a block diagram illustrating a configuration of the scheduling system according to the eighth exemplary embodiment of the present invention.

FIG. 23 is a flowchart illustrating a flow of processes in the scheduling system according to the eighth exemplary embodiment.

FIG. 24 is a block diagram illustrating a configuration of the scheduling system according to the ninth exemplary embodiment of the present invention.

FIG. 25 is a flowchart illustrating a flow of processes in the scheduling system according to the ninth exemplary embodiment.

### EXEMPLARY EMBODIMENT

Next, exemplary embodiments of the present invention will be described in detail with reference to drawings.

### First Exemplary Embodiment

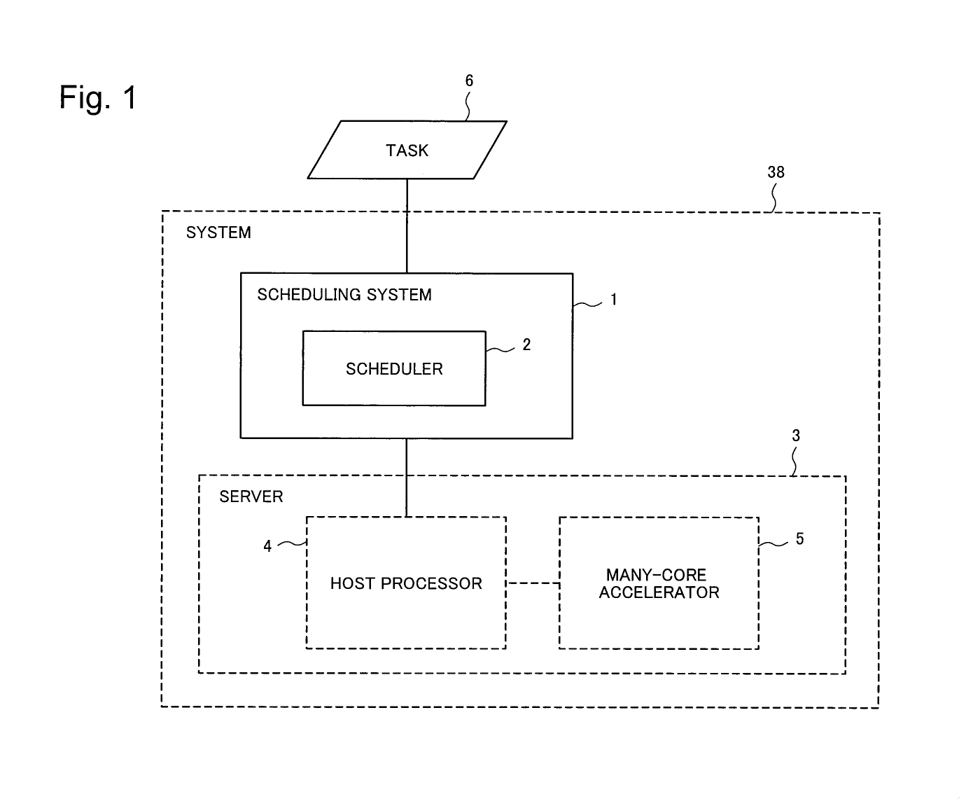

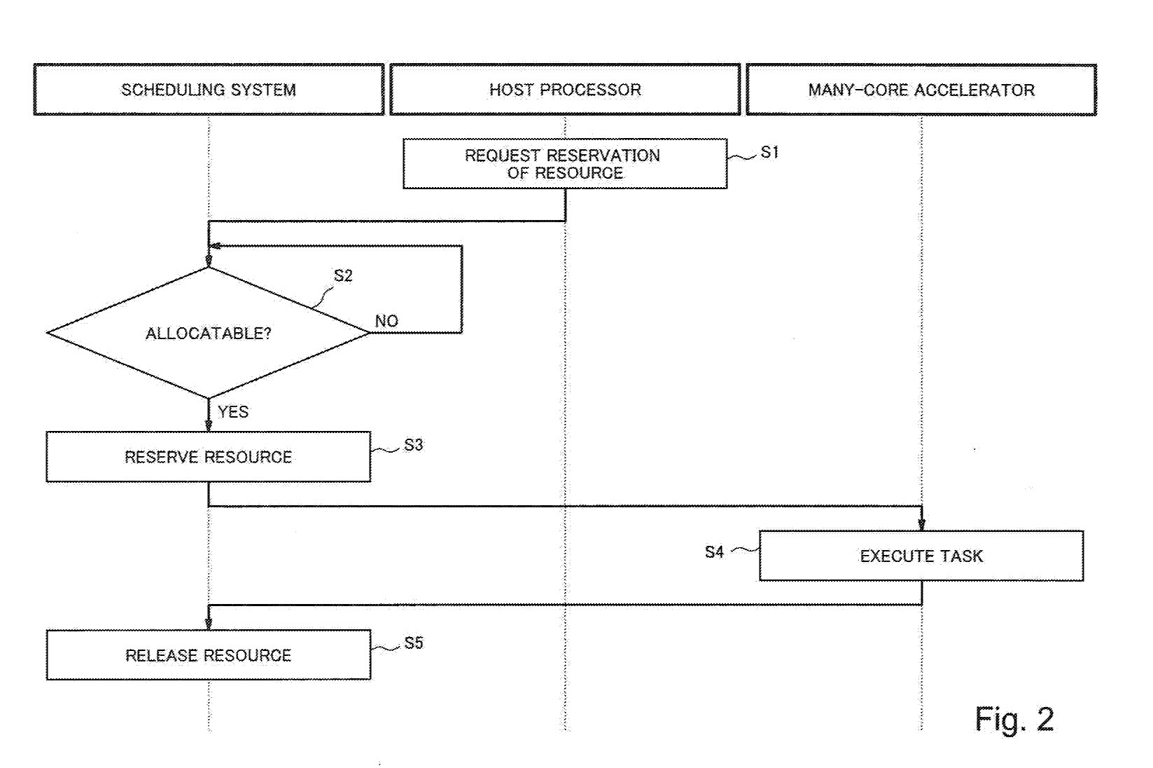

A configuration included in a scheduling system 1 according to a first exemplary embodiment of the present invention and processes performed by the scheduling system 1 will be described in detail referring to FIGS. 1 and 2. FIG. 1 is a block diagram illustrating a configuration of the scheduling system 1 according to the first exemplary embodiment of the present invention. FIG. 2 is a sequence diagram (flowchart) illustrating a flow of processes in the scheduling system 1 according to the first exemplary embodiment.

Referring to FIG. 1, a system 38 includes a server 3 (also referred to as “computer,” “calculation processing apparatus,” or “information processing apparatus”) that performs processing on a task 6 being a series of processes processed by a computer, and the scheduling system 1 according to the first exemplary embodiment. The scheduling system 1 includes a scheduler 2. The server 3 includes a host processor 4 (hereinafter also simply referred to as “processor”) and a many-core accelerator 5.

The host processor 4 performs processing such as control related to the many-core accelerator 5. First, the host processor 4 starts processing of the task 6. The host processor 4 reads an instruction (also referred to as command; hereinafter an instruction for reserving a resource is also referred to as “first instruction”) to reserve a resource (many-core accelerator 5) from the task 6. Then, the host processor 4 transmits a command for reserving a resource to the scheduling system 1 in accordance with the read first instruction (Step S1).

Next, the scheduler 2 checks whether or not a resource (hereinafter abbreviated as “resource reservation”) for the task 6 is allocatable when receiving the command (Step S2). The scheduler 2 reserves a resource (Step S3) when resource a resource is decided to be allocatable (YES in Step S2). The scheduler 2 checks again whether or not resource reservation is possible (Step S2) when resource is decided not to be allocatable (NO in Step S2), When the scheduler 2 decides that resource is allocatable (YES in Step S2), the many-core accelerator 5 executes the task 6 (Step S4).

When resource is decided not to be allocatable (NO in Step S2), the scheduler 2 waits for the resource to be released by performing the aforementioned process. Then, the scheduler 2 releases the reserved resource (Step S5).

The scheduling system 1 may be realized as, for example, a function in an operating system. The scheduling system 1 may also, for example, perform such a process as described above by transmitting/receiving a parameter, etc. related to a resource to/from an operating system.

As described in “BACKGROUND ART” a system described in PTL 1 to PTL 3 continues reserving a maximum resource that processes a series of tasks during a period between start and end of task processing. Therefore, when processing of a series of tasks uses only part of a resource, some part of the resource does not perform processing.

On the other hand, the scheduling system 1 according to the first exemplary embodiment reserves a resource in accordance with a request from a task, and then the reserved resource performs processing. The scheduling system 1 releases the resource by the host processor 4 commanding release of the resource. Even when the server 3 processes a series of tasks, the scheduling system 1 is able to allocate a resource for processing each task depending on task processing. Therefore, the scheduling system 1 according to the first exemplary embodiment is capable of, even when a series of tasks are processed, alleviating a situation in which only part of a resource performs processing.

In other words, the scheduling system 1 according to the first exemplary embodiment is capable of more efficiently enabling processing performance possessed by a resource to be exhibited.

### Second Exemplary Embodiment

Next, a second exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

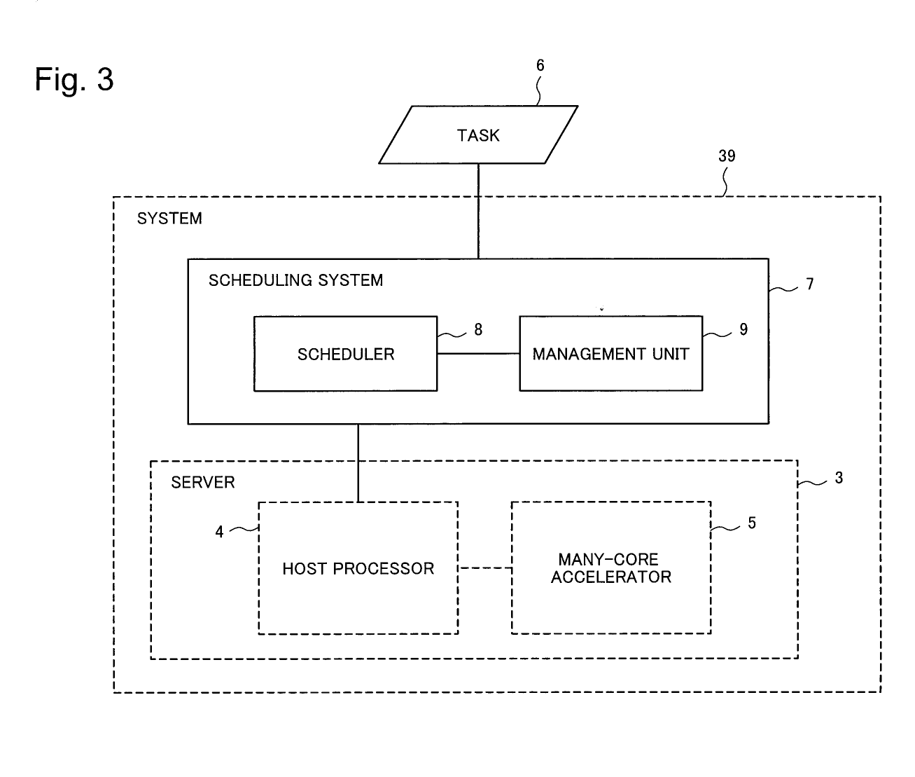

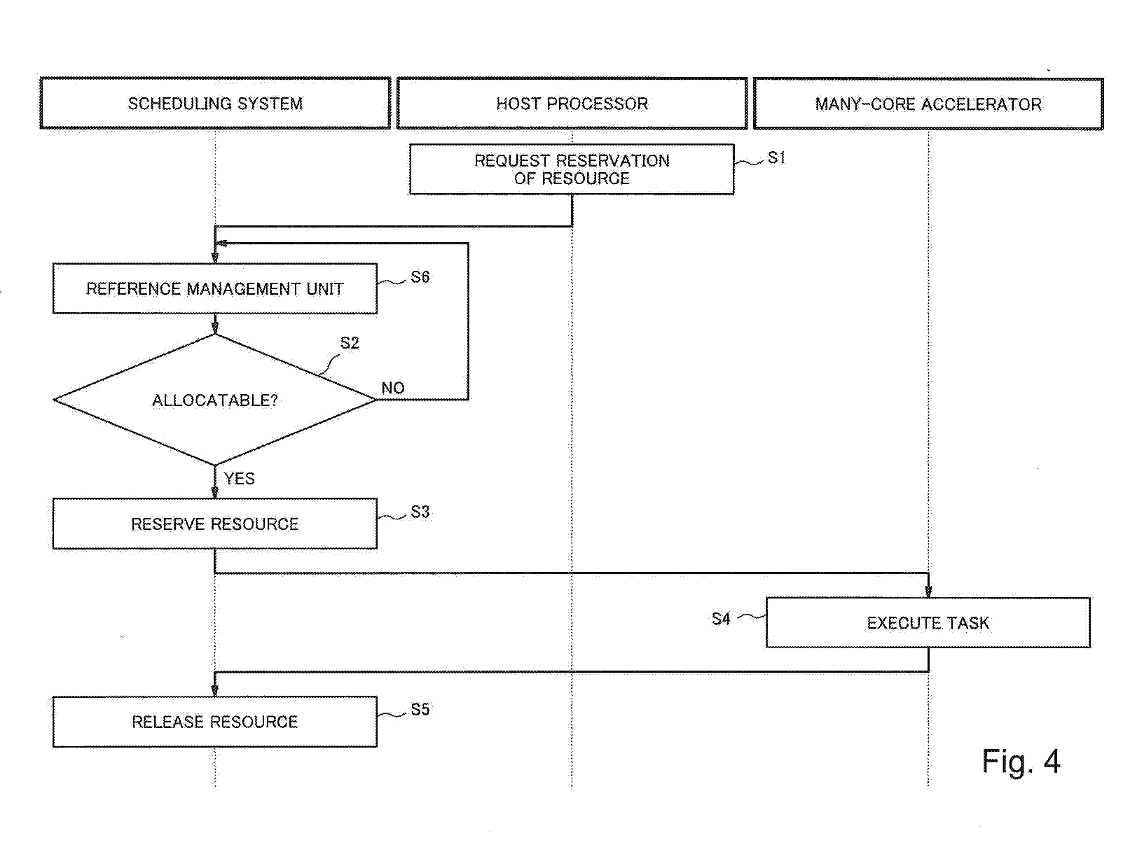

Referring to FIGS. 3 and 4, a configuration included in a scheduling system 7 according to the second exemplary embodiment of the present invention and processes performed by the scheduling system 7 will be described. FIG. 3 is a block diagram illustrating a configuration of the scheduling system 7 according to the second exemplary embodiment of the present invention. FIG. 4 is a sequence diagram illustrating a flow of processes in the scheduling system 7 according to the second exemplary embodiment.

Referring to FIG. 3, a system 39 includes the scheduling system 7 and the server 3. Further, the scheduling system 7 includes a scheduler 8 and a management unit 9. The management unit 9 manages usage status related to a resource included in the many-core accelerator 5. The scheduler 8, when receiving a request for reserving a resource (Step S1), reads information about usage status of the server 3 from the management unit 9 (Step S6). Then, the scheduler 8 decides, on the basis of the read information, whether or not a resource can be allocated (Step S2).

Since the management unit 9 manages information about usage status of a resource, the scheduler 8 is able to decide whether or not a resource can be allocated without referencing the outside. Therefore, the scheduling system 7 according to the second exemplary embodiment provides efficient management of a resource. Further, since the second exemplary embodiment includes a similar configuration to the first exemplary embodiment, the second exemplary embodiment can enjoy the similar effect to the first exemplary embodiment.

In other words, the scheduling system 7 according to the second exemplary embodiment is capable of more efficiently enabling processing performance possessed by a resource to be exhibited.

### Third Exemplary Embodiment

Next, a third exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

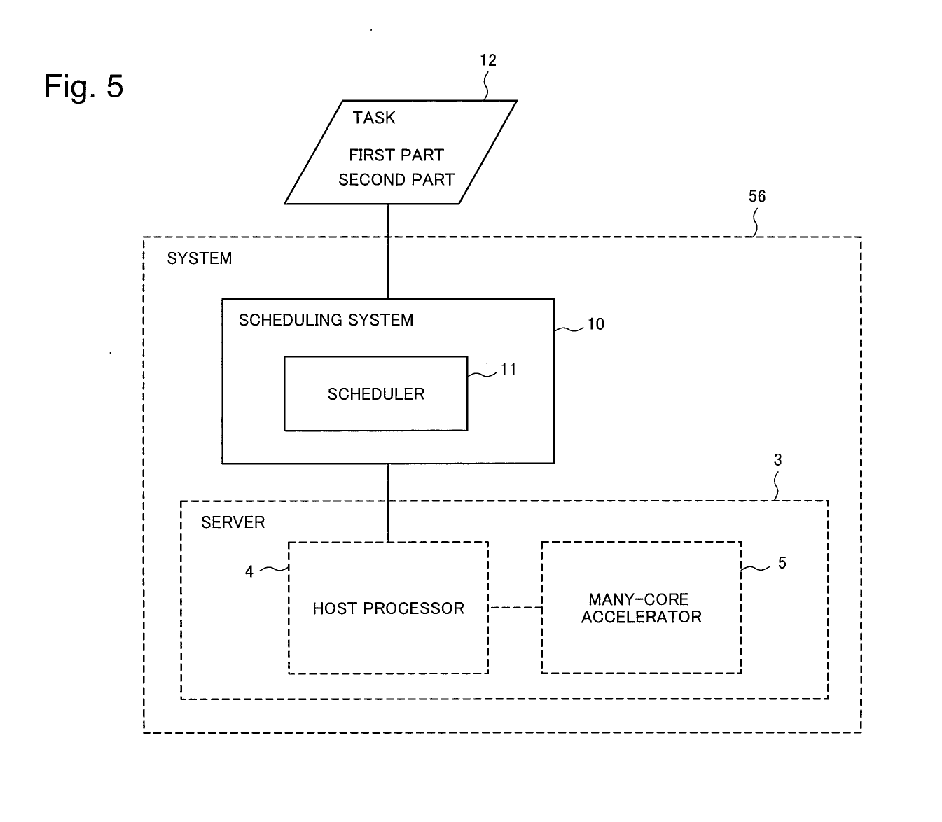

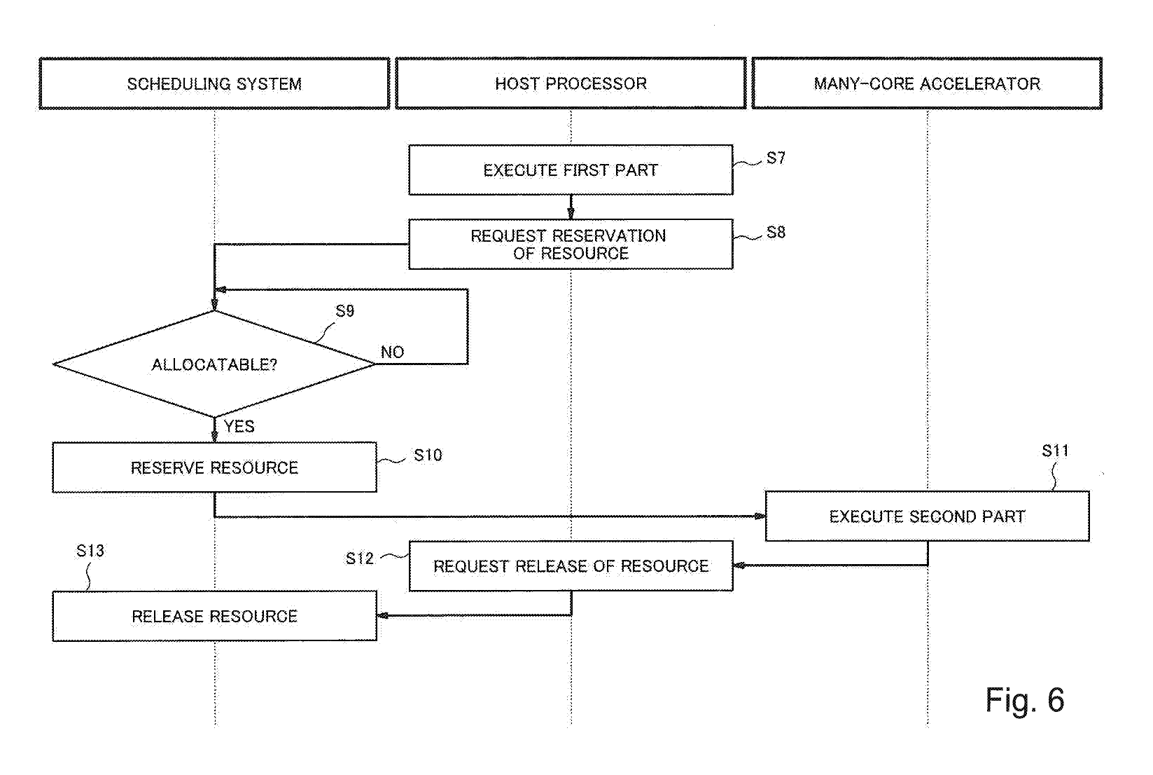

Referring to FIGS. 5 and 6, a configuration included in a scheduling system 10 according to the third exemplary embodiment of the present invention and processes performed by the scheduling system 10 will be described. FIG. 5 is a block diagram illustrating a configuration of the scheduling system 10 according to the third exemplary embodiment of the present invention. FIG. 6 is a sequence diagram illustrating a flow of processes in the scheduling system 10 according to the third exemplary embodiment.

Referring to FIG. 5, the scheduling system 10 includes a scheduler 11. A system 56 performs processing related to a task 12 including a first part and a second part by the server 3.

A host processor 4 executes the first part to be processed by the host processor 4 in the task 12 (Step S7). Then, the host processor 4 transmits a command for reserving a resource to the scheduler 11 in accordance with a first instruction (Step S8). When a resource is decided to be allocatable (YES in Step S9), the scheduler 11 reserves a resource (Step S10). When a resource is decided not to be allocatable (NO in Step S9), the scheduler 11 decides again whether or not a resource is allocatable (Step S9).

Next, the resource (included in the many-core accelerator 5) reserved by the scheduler 11 executes the second part to be processed by the resource (Step S11). Then, the host processor 4 issues a command for releasing the resource to the scheduler 11 in response to receiving a command for releasing the resource reserved by the scheduler 11 (hereinafter this command is referred to as “second instruction”) (Step S12). The scheduler 11 releases the reserved resource (Step S13) in response to receiving the command.

The first instruction includes, for example, information about the number of processors, etc. While the scheduler 11 determines an amount of resource on the basis of the aforementioned number of processors, etc., the amount of resource does not necessarily need to be equivalent to the aforementioned value. Further, the scheduler 11 may transmit information about a reserved resource. The information about the reserved resource may include information about the number of reserved processors, a list of available processor numbers, etc.

The task 12 includes the first part processed by the host processor 4, the second part, and the first instruction that reserves a resource for execution of the second part. Therefore, the scheduler 11 reserves a required resource before processing of the second part, and releases the resource after the reserved resource completes processing of the second part. In other words, the scheduling system 10 according to the third exemplary embodiment provides more detailed resource management compared with a system disclosed in PTL 1 to 3.

In other words, the scheduling system 10 according to the third exemplary embodiment is capable of more efficiently enabling processing performance possessed by a resource to be exhibited.

While, for convenience of description, the third exemplary embodiment is based on the first exemplary embodiment in the aforementioned description, the third exemplary embodiment may also be based on the second exemplary embodiment. In that case, the third exemplary embodiment can enjoy the similar effect to the second exemplary embodiment.

### Fourth Exemplary Embodiment

Next, a fourth exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

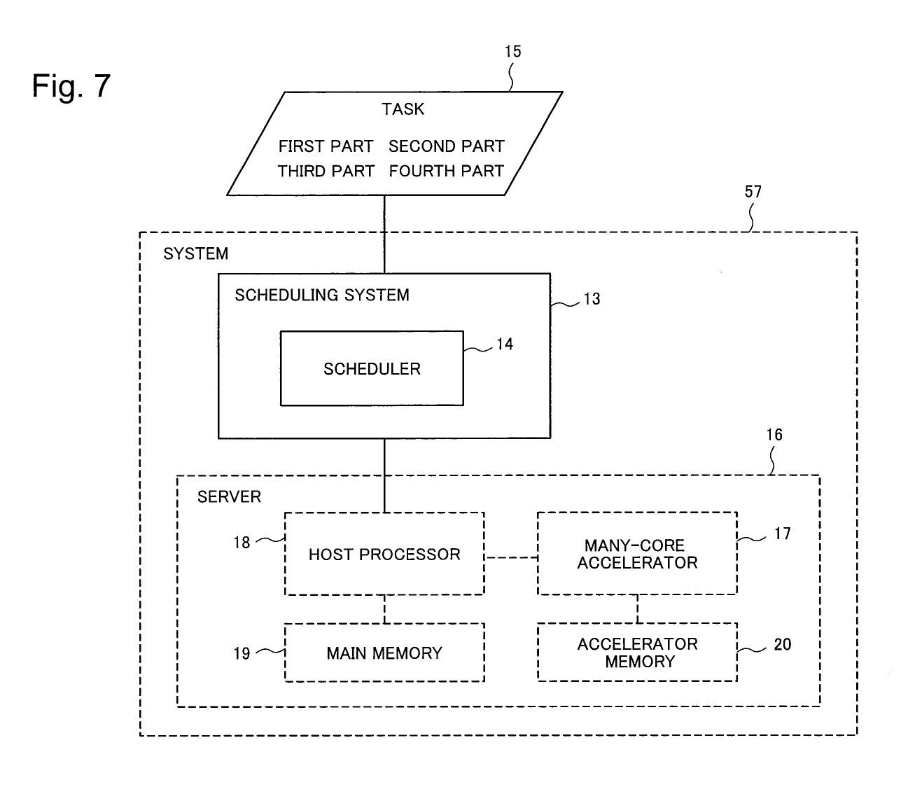

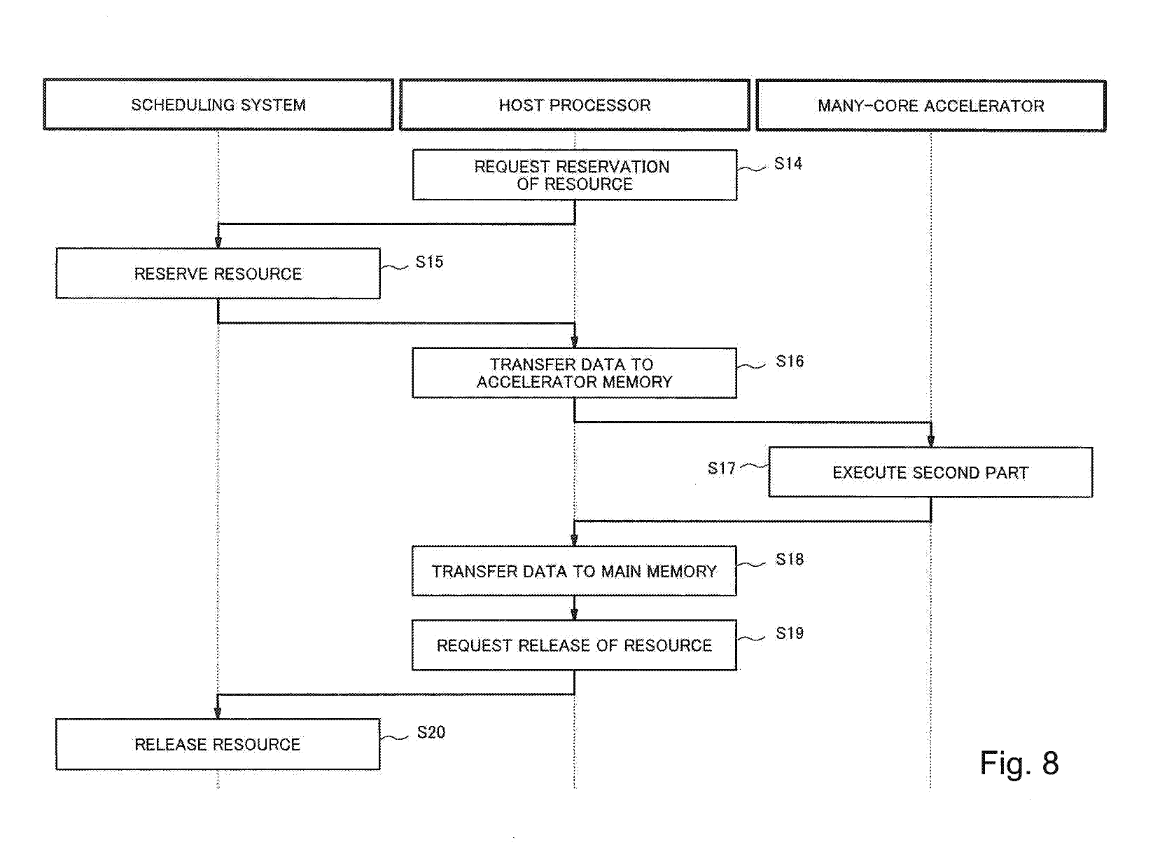

Referring to FIGS. 7 and 8, a configuration included in a scheduling system 13 according to the fourth exemplary embodiment of the present invention and processes performed by the scheduling system 13 will be described. FIG. 7 is a block diagram illustrating a configuration of the scheduling system 13 according to the fourth exemplary embodiment of the present invention. FIG. 8 is a sequence diagram illustrating a flow of processes in the scheduling system 13 according to the fourth exemplary embodiment.

Referring to FIG. 7, a system 57 includes a server 16 that processes a task 15 and a scheduling system 13 that manages a resource in the server 16.

The server 16 includes a host processor 18, a main memory 19 that stores data processed by the host processor 18, a many-core accelerator 17, and an accelerator memory 20 that stores data processed by the many-core accelerator 17.

The scheduling system 13 includes a scheduler 14. The task 15 includes, in addition to the aforementioned first part, first instruction, and second part, a third part that is an instruction for transmitting data from the main memory 19 to the accelerator memory 20 and a fourth part that is an instruction for transmitting data from the accelerator memory 20 to the main memory 19.

In accordance with the first instruction after executing the first part, the host processor 18 transmits a request for reserving a specific resource to the scheduling system 13 (Step S14). The scheduler 14 reserves a specific resource after receiving the request (Step S15). Step S15 is a collective expression including a series of processes in Steps S2 and S3 in FIG. 2, or a series of processes in Steps S2, S3, and S6 in FIG. 4. Next, the host processor 18 transmits data processed by the many-core accelerator 17 from the main memory 19 to the accelerator memory 20 (Step S16).

Next, the specific resource reserved by the scheduler 14 executes the second part (Step S17). Then, the host processor 18 transmits data processed by the specific resource from the accelerator memory 20 to the main memory 19 (Step S18). Then, the host processor 18 transmits a request for releasing the specific resource to the scheduling system 13 in accordance with the second instruction (Step S19). Then, the scheduler 14 releases the specific resource after receiving the request (Step S20).

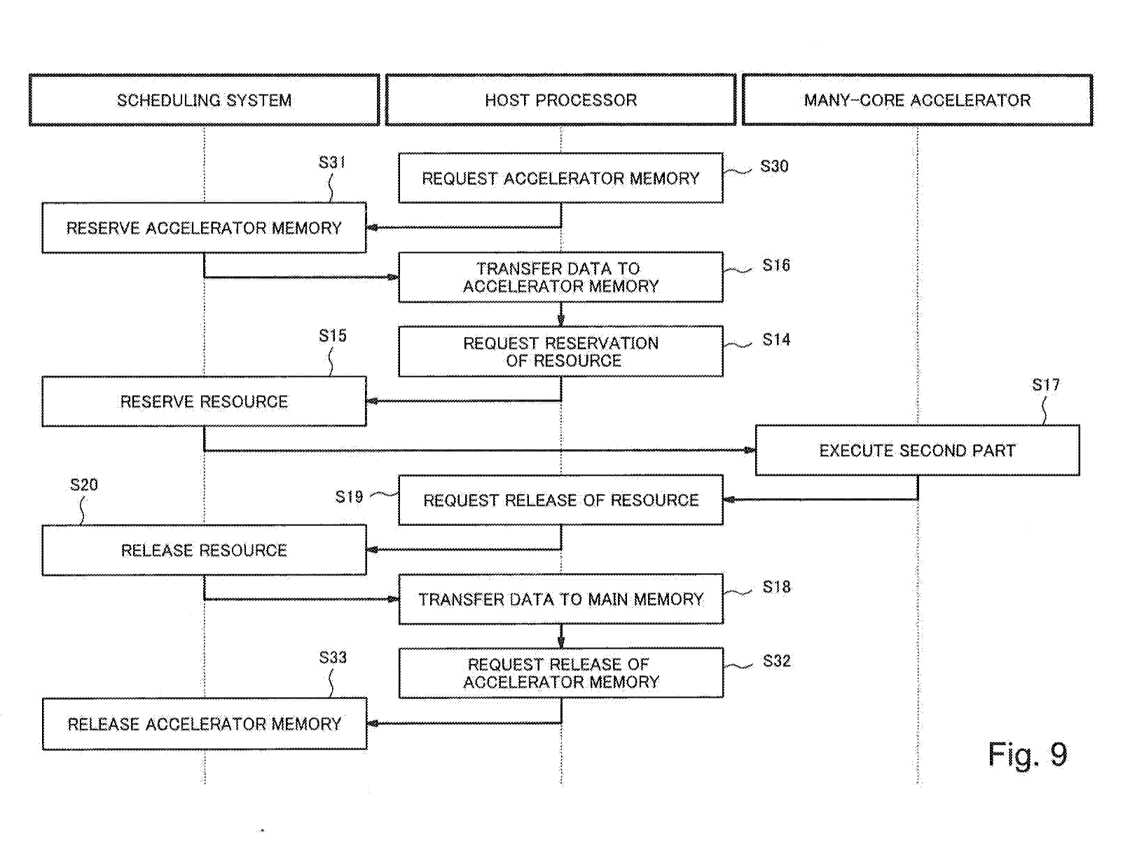

In the fourth exemplary embodiment, the scheduler 14 may reserve the accelerator memory 20 in addition to a processing apparatus in the many-core accelerator 17. In this case, a specific many-core accelerator 17 refers a specific accelerator memory 20. Referring to FIG. 9, processes executed when the scheduler 14 reserves the accelerator memory 20 will be described. FIG. 9 is a sequence diagram illustrating a second flow of processes in the scheduling system 13 according to the fourth exemplary embodiment.

After executing the first part, the host processor 18 transmits a request for reserving a specific accelerator memory 20 to the scheduling system 13 in accordance with the first instruction (Step S30). The scheduler 14 reserves a specific accelerator memory in response to receiving the request (Step S31). Then, the host processor 18 transmits data processed by the many-core accelerator 17 from the main memory 19 to the specific accelerator memory (Step S16).

Next, the host processor 18 makes a request for reserving a specific resource to the scheduling system 13 (Step S14). The scheduler 14 reserves a specific resource after receiving the request (Step S15). Step S15 is a collective expression including a series of processes in Steps S2 and S3 in FIG. 2, or a series of processes in Steps S2, S3, and S6 in FIG. 4.

Next, the specific resource reserved by the scheduler 14 executes the second part (Step S17). Then, the host processor 18 transmits a request for releasing the specific resource to the scheduling system 13 in accordance with the second instruction (Step S19). Then, the scheduler 14 releases the specific resource in response to receiving the request (Step S20). Then, the host processor 18 transmits data processed by the specific resource from the accelerator memory 20 to the main memory 19 (Step S18).

Next, the host processor 18 transmits a request for releasing the specific accelerator memory 20 to the scheduler 14 (Step S32). Then, the scheduler 14 releases the specific accelerator memory 20 in response to receiving the request (Step S33).

The scheduling system 13 according to the fourth exemplary embodiment is also capable of efficiently managing the accelerator memory 20 in the system 57. The system 57 includes a configuration where data processed by the many-core accelerator 17 is transmitted from the main memory 19 to the accelerator memory 20.

In other words, the scheduling system 13 according to the fourth exemplary embodiment is capable of more efficiently enabling processing performance possessed by a resource to be exhibited.

While, for convenience of description, the fourth exemplary embodiment is based on the first exemplary embodiment in the aforementioned description, the fourth exemplary embodiment may be based on the second exemplary embodiment or the third exemplary embodiment. In that case, the fourth exemplary embodiment can enjoy the similar effect to the second or third exemplary embodiment.

### Fifth Exemplary Embodiment

Next, a fifth exemplary embodiment based on the aforementioned third exemplary embodiment will be described.

In the following description, characteristic matters according to the present exemplary embodiment will be mainly described and an overlapping description of the same configuration as in the aforementioned third exemplary embodiment will be omitted by assigning the same reference sign thereto.

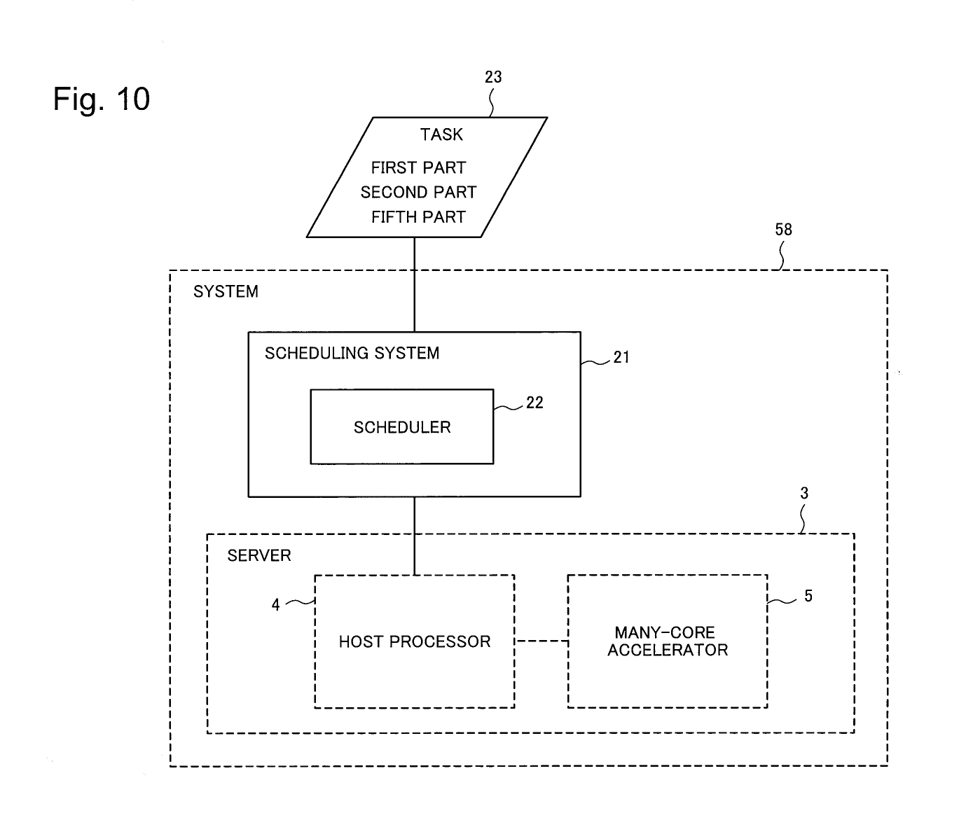

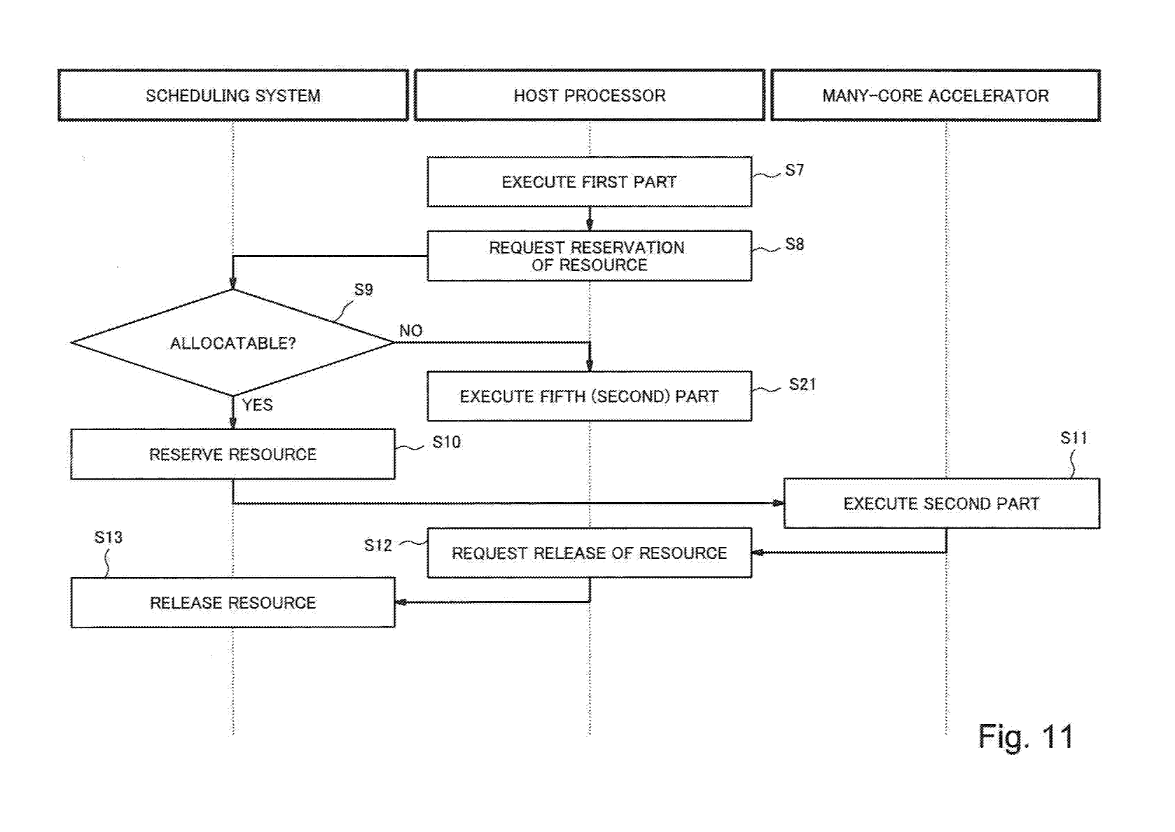

Referring to FIGS. 10 and 11, a configuration included in a scheduling system 21 according to the fifth exemplary embodiment of the present invention and processes performed by the scheduling system 21 will be described. FIG. 10 is a block diagram illustrating a configuration of the scheduling system 21 according to the fifth exemplary embodiment of the present invention. FIG. 11 is a sequence diagram illustrating a flow of processes in the scheduling system 21 according to the fifth exemplary embodiment.

Referring to FIG. 10, a system 58 includes the scheduling system 21 and the server 3 that processes a task 23. The scheduling system 21 includes a scheduler 22. The task 23 includes, in addition to a first part and a second part, a fifth part processed by a host processor 4 instead of the many-core accelerator 5 when the scheduler 22 is not able to reserve a specific resource. Processing in the fifth part is the same as processing in the second part. In other words, a result of execution of the fifth part by the host processor 4 is similar to a result of execution of the second part by a specific resource.

When the scheduler 22 decides that a resource cannot be allocated (NO in Step S9), the host processor 4 executes the fifth part (Step S21). When the scheduler 22 decides that a resource can be allocated (YES in Step S9), the scheduler 22 reserves a specific resource (Step S10).

The scheduling system 21 according to the fifth exemplary embodiment allows the host processor 4 to perform processing instead of the many-core accelerator 5 depending on resource status in the many-core accelerator 5. In other words, the task 23 can be processed more efficiently with the scheduling system 21 according to the fifth exemplary embodiment.

In other words, the scheduling system 21 according to the fifth exemplary embodiment is capable of more efficiently enabling processing performance possessed by a resource to be exhibited.

### Sixth Exemplary Embodiment

Next, a sixth exemplary embodiment based on the aforementioned first exemplary embodiment will be described.

In the following description, characteristic matters according to the present exemplary embodiment will be mainly described and an overlapping description of the same configuration as in the aforementioned first exemplary embodiment will be omitted by assigning the same reference sign thereto.

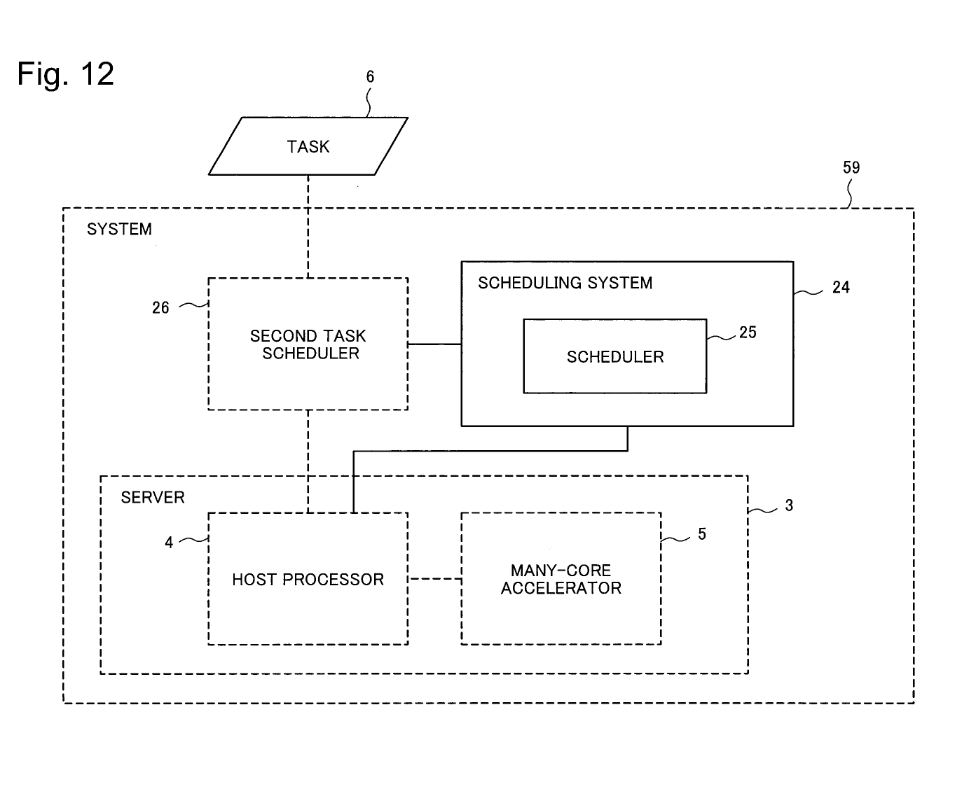

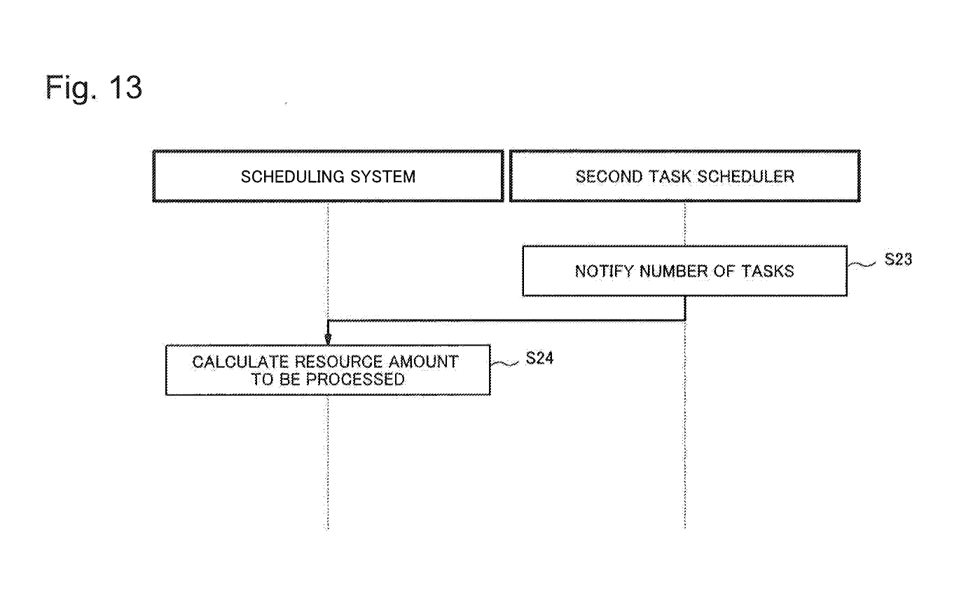

Referring to FIGS. 12 and 13, a configuration included in a scheduling system 24 according to the sixth exemplary embodiment of the present invention and processes performed by the scheduling system 24 will be described. FIG. 12 is a block diagram illustrating a configuration of the scheduling system 24 according to the sixth exemplary embodiment of the present invention. FIG. 13 is a flowchart illustrating a flow of processes in the scheduling system 24 according to the sixth exemplary embodiment.

Referring to FIG. 12, a system 59 includes the scheduling system 24, the server 3, and a second task scheduler 26 that controls putting a task 6 to the server 3. The scheduling system 24 includes a scheduler 25.

The second task scheduler 26 transmits, for example, information related to a task such as the number of tasks in the task 6 to the scheduling system 24 (Step S23). Then, the scheduler 25 calculates an amount of resource on the basis of the received information (Step S24). For example, the scheduler 25 may calculate an amount of resource by dividing the number of logical processors included in the many-core accelerator 5 by the number of tasks put to the server 3 by the second task scheduler 26, or may calculate an amount of resource by multiplying the amount of the value calculated above by two. A method by which the scheduling system 24 calculates an amount of resource is not limited to the aforementioned example.

The scheduling system 24 receives information usable for resource allocation control from the second task scheduler 26. Thus, the scheduling system 24 is able to perform scheduling more efficiently and adjust a load to the many-core accelerator 5.

In other words, the scheduling system 24 according to the sixth exemplary embodiment is capable of more efficiently enabling processing performance possessed by a resource to be exhibited.

### Seventh Exemplary Embodiment

Next, a seventh exemplary embodiment based on the aforementioned second exemplary embodiment will be described.

In the following description, characteristic matters according to the present exemplary embodiment will be mainly described and an overlapping description of the same configuration as in the aforementioned second exemplary embodiment will be omitted by assigning the same reference sign thereto.

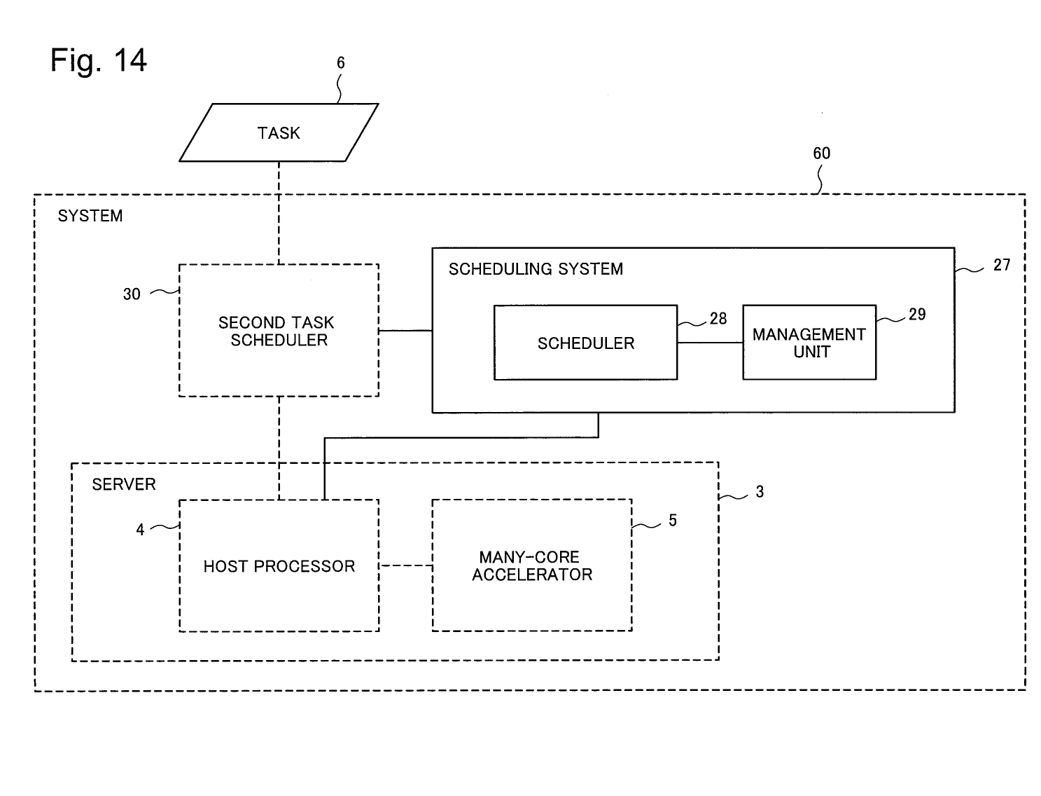

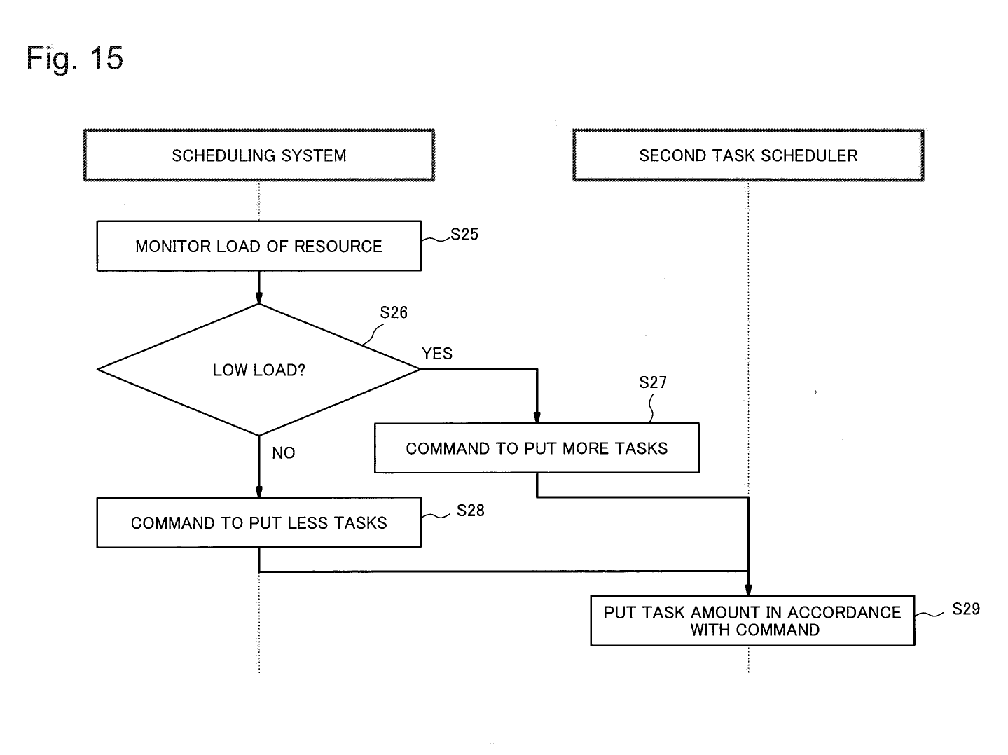

Referring to FIGS. 14 and 15, a configuration included in a scheduling system 27 according to the seventh exemplary embodiment of the present invention and processes performed by the scheduling system 27 will be described. FIG. 14 is a block diagram illustrating a configuration of the scheduling system 27 according to the seventh exemplary embodiment of the present invention. FIG. 15 is a sequence diagram illustrating a flow of processes in the scheduling system 27 according to the seventh exemplary embodiment.

Referring to FIG. 14, a system 60 includes the scheduling system 27, a second task scheduler 30, and the server 3 that processes a task 6. The scheduling system 27 includes a scheduler 28 and a management unit 29.

The scheduler 28 reads load information including a load value representing the load of a resource in the many-core accelerator 5 from the management unit 29 (Step S25). Then, the scheduler 28 compares a predetermined second threshold value with the read load value. When the read load value is decided to be less than the predetermined second threshold value, in other words, when the load status is decided to be low (YES in Step S26), the scheduler 28 transmits a signal requesting more tasks to be input to the second task scheduler 30 (Step S27). The scheduler 28 compares a predetermined first threshold value with the read load value. When the read load value is decided to be greater than the predetermined first threshold value, in other words, when the load status is decided to be high (NO in Step S26), the scheduler 28 transmits a signal requesting less tasks to be input to the second task scheduler 30 (Step S28).

Next, the second task scheduler 30 adjusts a task amount in accordance with the signal (Step S29).

Since the scheduling system 27 transmits a signal to the second task scheduler 30 regarding load information about a resource, the scheduling system 27 according to the seventh exemplary embodiment is able to adjust a load to the many-core accelerator 5 to an appropriate level.

In other words, the scheduling system 27 according to the seventh exemplary embodiment is capable of more efficiently enabling processing performance possessed by a resource to be exhibited.

### Eighth Exemplary Embodiment

Next, an eighth exemplary embodiment based on the aforementioned fourth exemplary embodiment will be described.

In the following description, characteristic matters according to the present exemplary embodiment will be mainly described and an overlapping description of the same configuration as in the aforementioned fourth exemplary embodiment (mainly FIGS. 7 to 9) will be omitted by assigning the same reference sign thereto.

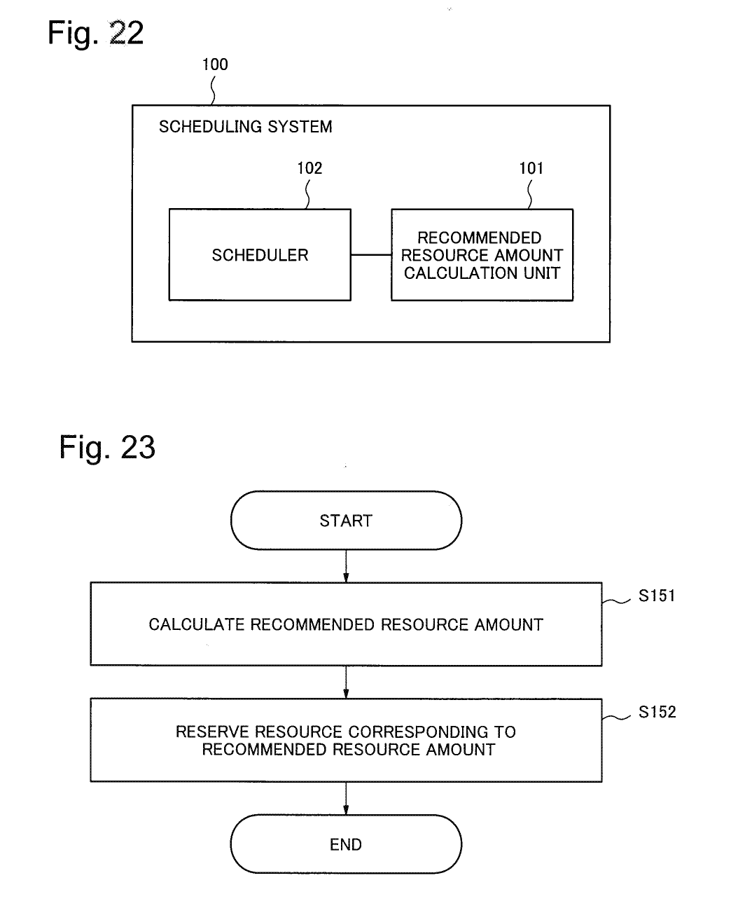

Referring to FIGS. 22 and 23, a configuration included in a scheduling system 100 according to the eighth exemplary embodiment of the present invention and processes performed by the scheduling system 100 will be described. FIG. 22 is a block diagram illustrating a configuration of the scheduling system 100 according to the eighth exemplary embodiment of the present invention. FIG. 23 is a flowchart illustrating a flow of processes in the scheduling system 100 according to the eighth exemplary embodiment.

Referring to FIG. 22, the scheduling system 100 includes a scheduler 102 and a recommended resource amount calculation unit 101. The scheduling system 100 is, for example, a scheduling system that controls an operation of the system 57 (FIG. 7) similar to the scheduling system according to the fourth exemplary embodiment.

The scheduling system 100 receives a request for reserving a resource (Step S14 in FIGS. 8 and 9, hereinafter referred to as “resource reservation request”) included in a many-core accelerator (not illustrated) from a host processor (not illustrated).

First, the scheduler 102 transmits the received resource reservation request to the recommended resource amount calculation unit 101.

The recommended resource amount calculation unit 101 receives the resource reservation request transmitted by the scheduler 102 and calculates a recommended resource amount in accordance with the received resource reservation request. Information received by the recommended resource amount calculation unit 101 includes, for example, a capacity of a storage area reserved by a task in an accelerator memory 20 (illustrated in FIG. 7) or a capacity of a storage area originally included in the accelerator memory 20 (illustrated in FIG. 7). The information also includes a capacity of a storage area in an unused (also referred to as “dormant,” “idle,” “standby,” etc.) state within a storage area included in the accelerator memory 20 (illustrated in FIG. 7), or a resource amount requested by the task. Further, the information includes a resource amount originally included in the many-core accelerator 17 (illustrated in FIG. 7), or a resource amount in an unused state within a resource amount originally included in the many-core accelerator 17 (illustrated in FIG. 7). The recommended resource amount calculation unit 101 may receive a plurality of types of information. The recommended resource amount calculation unit 101 does not necessarily need to receive all of the information described above.

An “unused state” represents a state in which a target apparatus is not assigned to a task, etc.

Next, the recommended resource amount calculation unit 101 calculates, on the basis of the received information, a recommended resource amount in accordance with a predetermined resource calculation method (Step S151).

For example, the recommended resource amount calculation unit 101 calculates a first recommended resource candidate in accordance with Equation 1.

First recommended resource candidate=x÷y×z (1)

(where x denotes a capacity of a storage area in the accelerator memory 20 reserved by a task,

y denotes a capacity of a storage area originally included in the accelerator memory 20, and

z denotes a resource amount originally included in a calculation resource in the many-core accelerator 17 [for example, “the number of threads that can be processed in parallel or in pseudo-parallel (hereinafter collectively referred to as ‘in parallel’)”]).

For example, a resource amount originally included in the many-core accelerator 17 can be calculated in accordance with Equation 2 when a core includes a hyper-threading function.

z=“the number of cores”×“the number of threads that can be processed in parallel by the hyper-threading function” (2)

A resource amount originally included in the many-core accelerator 17 does not necessarily need to be expressed by Equation 2.

Alternatively, the recommended resource amount calculation unit 101 may calculate a first recommended resource candidate in accordance with Equation 3.

First recommended resource candidate=x÷(x+a)×b (3)

(where x denotes a capacity of a storage area reserved by a task in the accelerator memory 20,

a denotes a capacity of a storage area in an unused state in the accelerator memory, and

b denotes a resource amount in an unused state within a resource in the many-core accelerator 17).

The recommended resource amount calculation unit 101 outputs the calculated first recommended resource candidate as a recommended resource amount.

Further, the recommended resource amount calculation unit 101 may compare a requested amount in the received resource reservation request (hereinafter referred to as “received requested amount”) with the first recommended resource candidate and calculate a recommended resource amount on the basis of the comparison result.

For example, when the received request amount is greater than the first recommended resource candidate, the recommended resource amount calculation unit 101 outputs the received requested amount as a recommended resource amount. On the other hand, when the first recommended resource candidate is smaller than the received requested amount, the recommended resource amount calculation unit 101 may output the first recommended resource candidate as a recommended resource amount. In this case, a predetermined resource calculation method is a calculation method in which the smaller value of the received requested amount and the first recommended resource candidate is outputted as a recommended resource amount. A recommended resource amount calculated in such a manner is hereinafter referred to as “second recommended resource candidate”.

Further, the recommended resource amount calculation unit 101 may compare a resource amount originally included in the many-core accelerator 17 with the second recommended resource candidate and calculate a recommended resource amount on the basis of the comparison result.

For example, when a resource amount originally included in the many-core accelerator 17 is decided to be greater than the second recommended resource candidate, the recommended resource amount calculation unit 101 outputs the second recommended resource candidate as a recommended resource amount. Further, when a resource amount originally included in the many-core accelerator 17 is decided to be smaller than the second recommended resource candidate, the recommended resource amount calculation unit 101 compares the received requested amount with the first recommended resource candidate. When the received requested amount is decided to be smaller than the first recommended resource candidate, the recommended resource amount calculation unit 101 outputs the received requested amount as a recommended resource amount. Further, when the received requested amount is decided to be greater than the first recommended resource candidate, the recommended resource amount calculation unit 101 outputs the first recommended resource candidate as a recommended resource amount.

The recommended resource amount calculation unit 101 may read information about a capacity of a storage area reserved by the task within the accelerator memory 20 from the many-core accelerator 17. Alternatively, the recommended resource amount calculation unit 101 may read the aforementioned area information and a resource reservation request requested to the scheduling system 100 by the task.

Further, the recommended resource amount calculation unit 101 may calculate a capacity of a storage area reserved by the task in the accelerator memory 20 on the basis of two types of information described below. The two types of information are, a history of reservation of the accelerator memory by the scheduler 102 (Step S31 in FIG. 9), and a history of release of the accelerator memory by the scheduler 102 (Step S33 in FIG. 9).

The recommended resource amount calculation unit 101 transmits the calculated recommended resource amount to the scheduler 102.

The scheduler 102 receives the recommended resource amount transmitted by the recommended resource amount calculation unit 101. Then, the scheduler 102 reserves a resource out of a resource included in the many-core accelerator 17 depending on the received recommended resource amount (Step S152). Then, the resource reserved by the scheduler 102 executes processing in a second part (Step S17 in FIG. 9).

Since the eighth exemplary embodiment includes a similar configuration to the fourth exemplary embodiment, the eighth exemplary embodiment can enjoy the similar effect to the fourth exemplary embodiment. In other words, the scheduling system 100 according to eighth exemplary embodiment is capable of more efficiently enabling processing performance possessed by a resource to be exhibited.

When a plurality of tasks reserve a storage area beyond a capacity of a storage area in the accelerator memory 20, the many-core accelerator 17 is not able to perform processes in the accelerator memory 20 in spite of having a capability to process the tasks. In other words, a situation in which the processing performance possessed by a resource cannot be exhibited in the many-core accelerator 17 may occur.

On the other hand, in the eighth exemplary embodiment, the recommended resource amount calculation unit 101 calculates a recommended resource amount depending on a capacity of a storage area reserved by a task in the accelerator memory 20 as explained by referring to Equation 1. Consequently, the scheduling system 100 according to the present exemplary embodiment is able to avoid the aforementioned situation. In other words, the scheduling system 100 according to the eighth exemplary embodiment is capable of yet more efficiently enabling processing performance possessed by a resource to be exhibited.

### Ninth Exemplary Embodiment

Next, a ninth exemplary embodiment based on the aforementioned eighth exemplary embodiment will be described.

In the following description, characteristic matters according to the present exemplary embodiment will be mainly described and an overlapping description of the same configuration as in the aforementioned eighth exemplary embodiment will be omitted by assigning the same reference sign thereto.

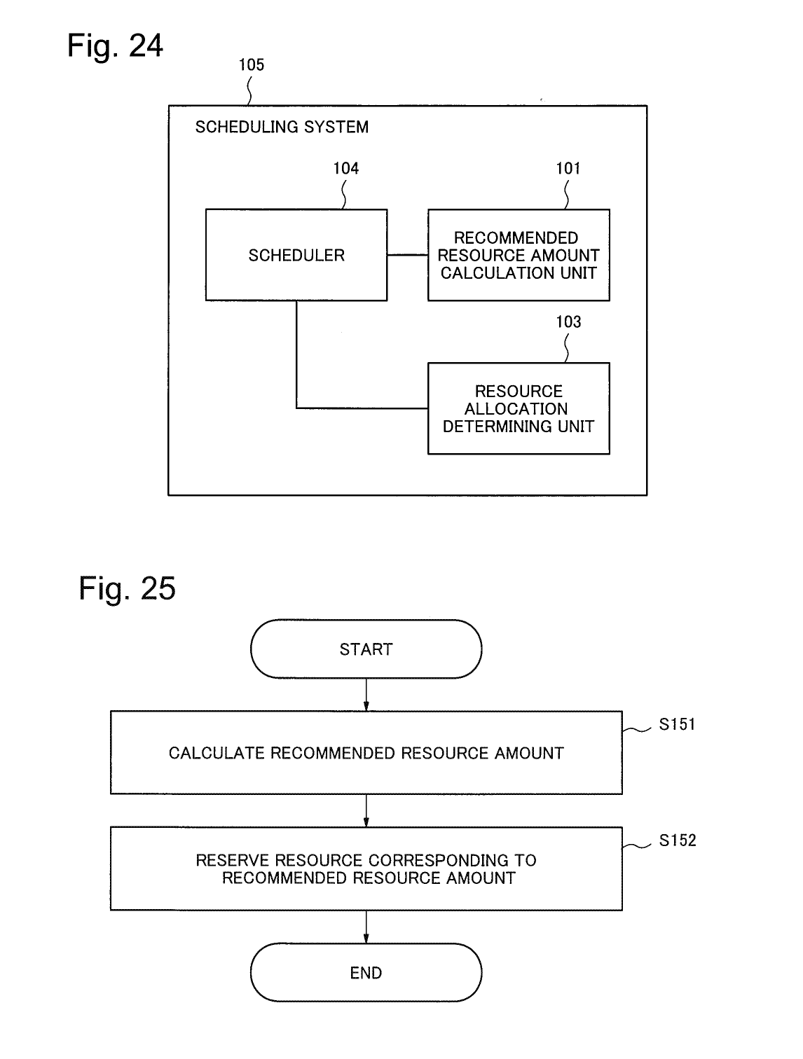

Referring to FIGS. 24 and 25, a configuration included in a scheduling system 105 according to the ninth exemplary embodiment of the present invention and processes performed by the scheduling system 105 will be described. FIG. 24 is a block diagram illustrating a configuration of the scheduling system 105 according to the ninth exemplary embodiment of the present invention. FIG. 25 is a flowchart illustrating a flow of processes in the scheduling system 105 according to the ninth exemplary embodiment.

Referring to FIG. 24, the scheduling system 105 includes a scheduler 104, a recommended resource amount calculation unit 101, and a resource allocation determining unit 103. The scheduling system 105 is, for example, a scheduling system that controls an operation of an entire system similar to the many-core system according to the fourth exemplary embodiment.

The resource allocation determining unit 103 determines a specific resource that processes a second part out of a resource reserved by the scheduler 104 in accordance with a predetermined selection method (Step S153). For example, the resource allocation determining unit 103 determines a specific resource by selecting a combination of resources capable of most efficiently processing the second part (Step S17).

For example, the resource allocation determining unit 103 selects a combination of resources capable of providing efficient processing on the basis of a characteristic possessed by a many-core accelerator 17 (not illustrated; see, for example, FIG. 7). In this case, the resource allocation determining unit 103 selects, for example, a combination of resources capable of most efficiently processing the second part.

A characteristic possessed by the many-core accelerator 17 includes, for example, a characteristic of a hyper-threading function described below. For example, it is assumed that each core in the many-core accelerator 17 has a hyper-threading function capable of processing 4 threads in parallel. It is further assumed that each core does not get performance improvement corresponding to the number of threads even if the number of threads processed in parallel increases.

It is further assumed that a recommended resource amount is 8 (threads) and a resource reserved by the scheduler 104 is 4 cores. In this case, processing performance of processing the second part by a hyper-threading function for “4 cores×2 threads” is higher than processing the second part by a hyper-threading function for “2 cores×4 threads”. This is because, due to the aforementioned characteristic possessed by each core, a hyper-threading function for 4 threads in parallel gets less performance improvement corresponding to the number of threads.

In other words, in the aforementioned example, the resource allocation determining unit 103 determines a hyper-threading function for “4 cores×2 threads” as a specific resource on the basis of the aforementioned characteristic. In this case, the predetermined selection method is a method for selecting a resource capable of providing efficient processing on the basis of the aforementioned characteristic.

Alternatively, the resource allocation determining unit 103 may calculate a specific resource associated with the best processing performance on the basis of information associating a configuration included in a specific resource with performance of processing the second part by the specific resource. In this case, the predetermined selection method is a method for selecting a resource capable of providing efficient processing on the basis of the aforementioned information.

Since the ninth exemplary embodiment includes a similar configuration to the eighth exemplary embodiment, the ninth exemplary embodiment can enjoy similar effect to the eighth exemplary embodiment. In other words, the scheduling system according to the ninth exemplary embodiment is capable of more efficiently enabling processing performance possessed by a resource to be exhibited.

Further, in the ninth exemplary embodiment, the resource allocation determining unit 103 specifies a resource with the best processing performance as described above. Therefore, the scheduling system 105 according to the ninth exemplary embodiment is capable of yet more efficiently enabling processing performance possessed by a resource to be exhibited.

### Hardware Configuration Example

A configuration example of a hardware resource realizing a scheduling system according to each exemplary embodiment of the present invention described above with a single calculation processing apparatus (information processing apparatus, computer) will be described. Such a scheduling system may be physically or functionally realized by use of at least two calculation processing apparatuses. Further, such a scheduling system may be realized as a dedicated apparatus.

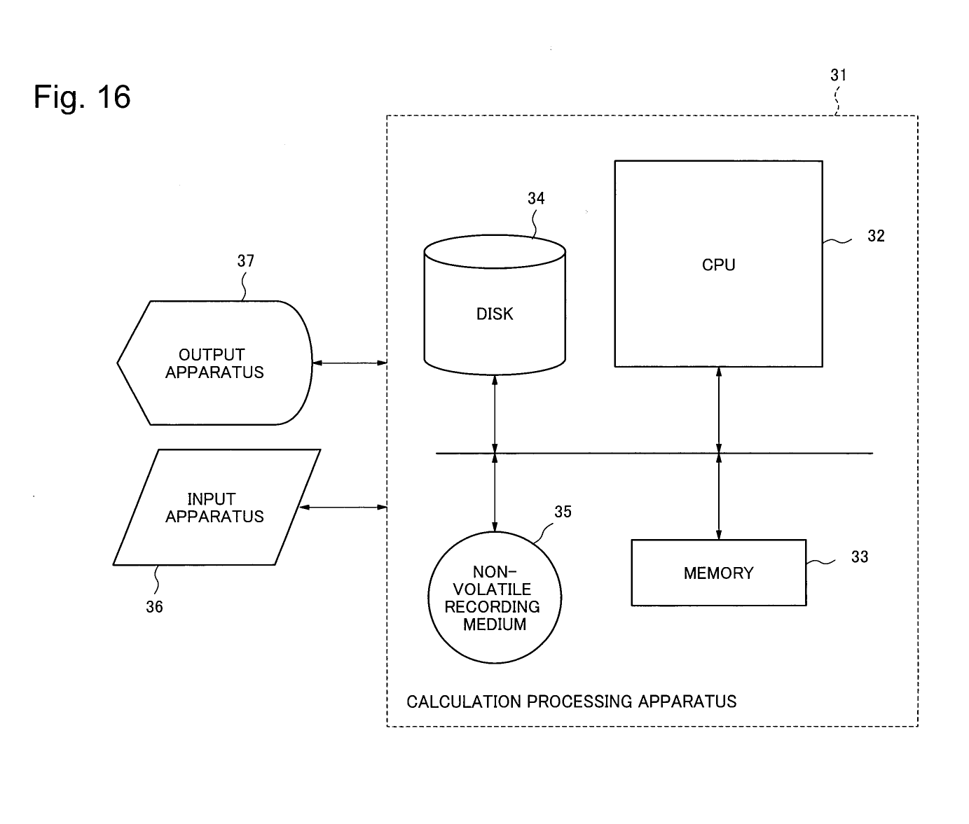

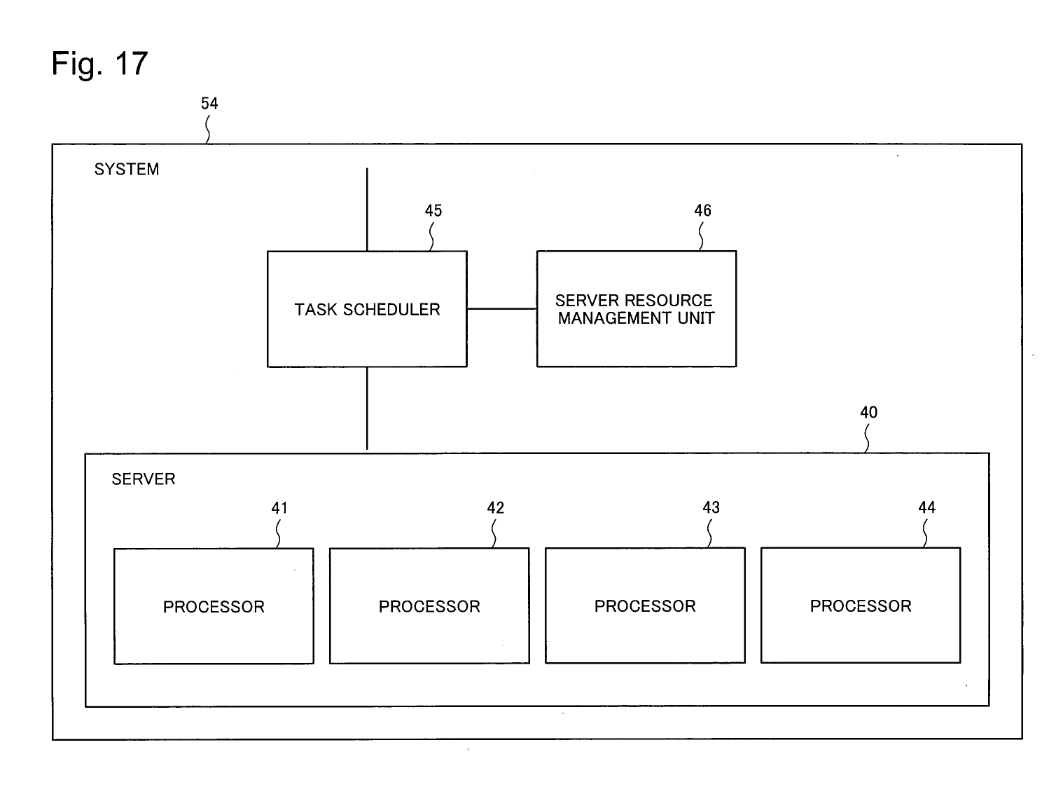

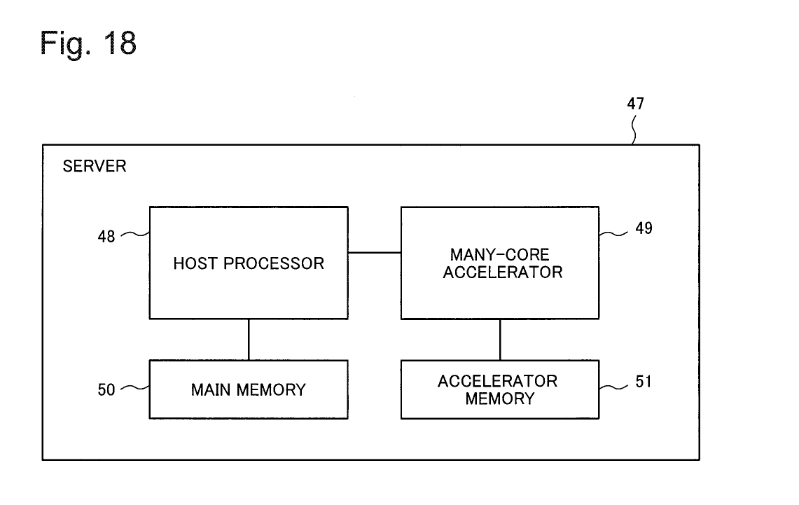

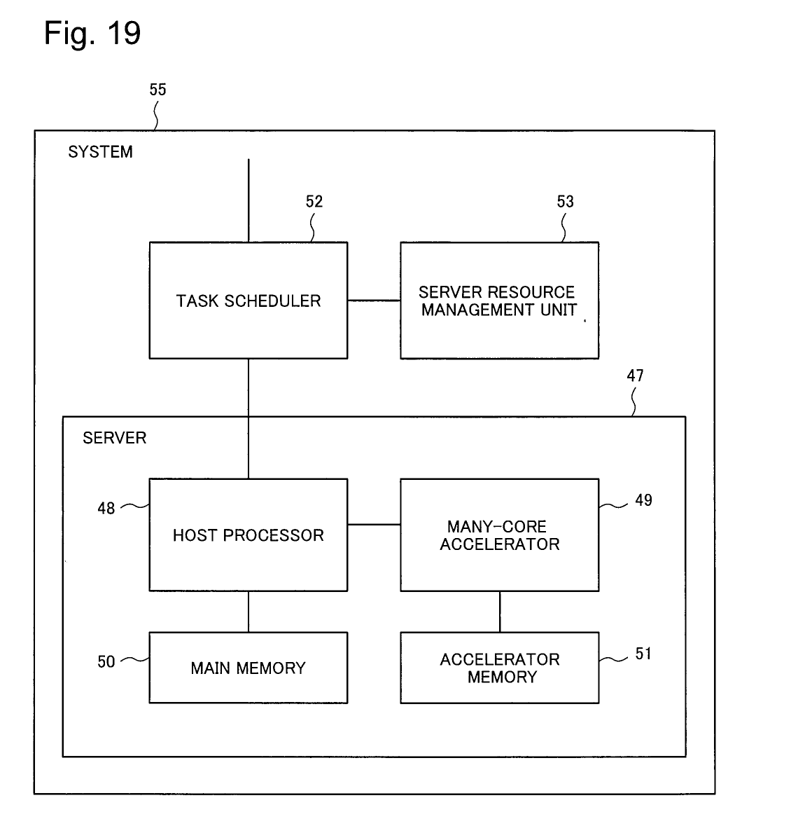

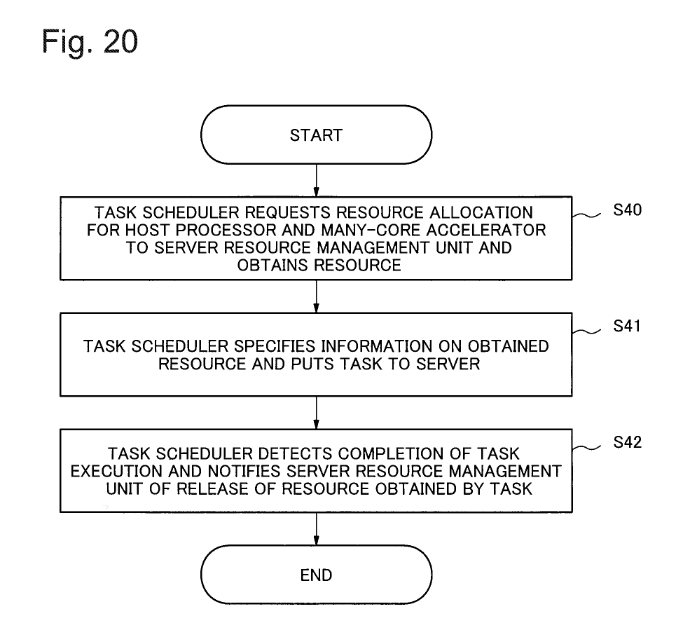

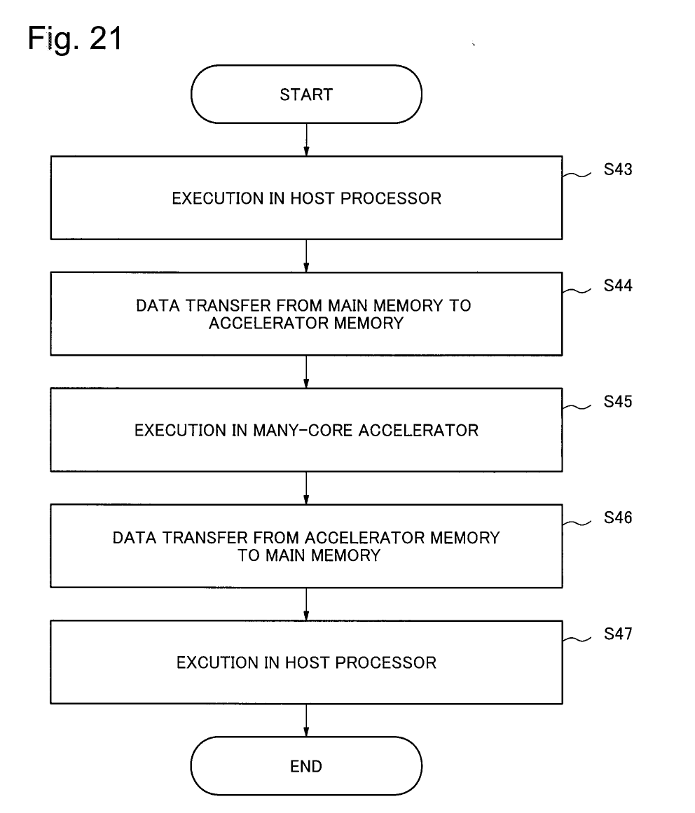

FIG. 16 is a schematic diagram illustrating a hardware configuration of a calculation processing apparatus capable of realizing a calculation searching system according to the first to ninth exemplary embodiments. A calculation processing apparatus 31 includes a Central Processing Unit (hereinafter abbreviated as “CPU”) 32, a memory 33, a disk 34, a non-volatile recording medium 35, an input apparatus 36, and an output apparatus 37.

The non-volatile recording medium 35 refers to, for example, a Compact Disc, a Digital Versatile Disc, a Blu-ray Disc (registered trademark), a Universal Serial Bus memory (USB memory), etc. that are computer-readable, capable of holding such a program without power supply, and portable. The non-volatile recording medium 35 is not limited to the aforementioned media. Further, such a program may be transferred via a communication network instead of the non-volatile recording medium 35.

When executing a software program (computer program, hereinafter simply referred to as “program”) stored in the disk 34, the CPU 32 copies the program to the memory 33 and performs arithmetic processing. The CPU 32 reads data required for executing the program from the memory 33. When a display is required, the CPU 32 displays an output result on the output apparatus 37. When inputting a program from outside, the CPU 32 reads the program from the input apparatus 36. The CPU 32 interprets and executes a scheduling program (processes performed by the scheduling system in FIG. 2, 4, 6, 8, 9, 11, 13, 15, 23, or 25) in the memory 33 corresponding to a function (process) represented by each unit in the aforementioned FIG. 1, 3, 5, 7, 10, 12, 14, 22, or 24. The CPU 32 sequentially performs processes described in each of the aforementioned exemplary embodiments of the present invention.

In such a case, the present invention can be regarded as realizable also by such a scheduling program. Further, the present invention can be regarded as realizable also by a computer-readable recording medium containing such a scheduling program.

The aforementioned respective exemplary embodiments may also be described in whole or part as the following Supplemental Notes. However, the present invention exemplified in each of the aforementioned exemplary embodiments is not limited to the following.

### (Supplemental Note 1)

A scheduling system including:

a scheduler configured to determine a specific resource that processes a task in accordance with a first instruction to be included in the task processed by a calculation processing apparatus, which includes a many-core accelerator being resource and a processor controlling the resource, and to reserve the resource.

### (Supplemental Note 2)

The scheduling system according to Supplemental Note 1, further comprising:

management means configured to manage usage status of the resource, wherein

the scheduler determines the specific resource by reading the usage status stored in the management means.

### (Supplemental Note 3)

The scheduling system according to Supplemental Note 1 or 2, wherein

the task includes a first part processed by the processor, the first instruction, a second part processed by the resource, and a second instruction for releasing the specific resource, and

the scheduler reserves the specific resource in accordance with the first instruction after the processor processes the first part, and releases the specific resource in accordance with the second instruction after the specific resource processes the second part.

### (Supplemental Note 4)

The scheduling system according to Supplemental Note 3, wherein

the calculation processing apparatus further includes a memory accessed by the processor and an accelerator memory accessed by the many-core accelerator,

the task includes the first part, the first instruction, a third part for transferring data from the memory to the accelerator memory, the second part, a fourth part for transferring data from the accelerator memory to the memory, and the second instruction, and

the scheduler reserves the specific resource during processing of the first part performed by the processor and processing of the third part performed by the processor in accordance with the first instruction, and releases the specific resource after processing of the fourth part performed by the processor in accordance with the second instruction.

### (Supplemental Note 5)

The scheduling system according to Supplemental Note 4, wherein

the scheduler reserves a specific accelerator memory in accordance with the first instruction, reserves the specific resource after processing of the third part performed by the processor, releases the specific resource in accordance with the second instruction after processing of the second part performed by the specific resource, and releases the specific accelerator memory after processing of the fourth part performed by the processor.

### (Supplemental Note 6)

The scheduling system according to Supplemental Note 3 or 4, wherein

the task further includes a fifth part for directing a process included in the second part to the processor, and

the scheduler determines that the processor performs processing of the fifth part when the specific resource cannot be reserved in the usage status, and determines that the specific resource performs processing of the second part when the specific resource can be determined.

### (Supplemental Note 7)

The scheduling system according to any one of Supplemental Notes 1 to 6, further comprising:

a second task scheduler configured to control an allocation of the task to the calculation processing apparatus, wherein

the scheduler determines the specific resource in accordance with information related to the task notified to the scheduler by the second task scheduler.

### (Supplemental Note 8)

The scheduling system according to any one of Supplemental Notes 2 to 6, wherein

the scheduler transmits a command for reducing the task to the second task scheduler when a load on the resource is greater than a predetermined first threshold value and transmits a command for increasing the task when a load on the resource is smaller than a predetermined second threshold value by referencing the control means.

### (Supplemental Note 9)

The scheduling system according to Supplemental Note 3 or 4, further comprising:

recommended resource amount calculation means configured to calculate a recommended resource amount in accordance with a predetermined resource calculation method on the basis of at least one type of information out of a storage capacity of the accelerator memory reserved by the task issuing the first instruction, a storage capacity originally included in the accelerator memory, a resource amount requested by the task, or a resource amount originally included in the resource in the many-core accelerator and a storage capacity of an area in an unused state in the accelerator memory, wherein

the scheduler reserves a specific resource depending on the recommended resource amount.

### (Supplemental Note 10)

The scheduling system according to Supplemental Note 9, further comprising:

resource allocation determining means configured to select a resource capable of processing the second part in accordance with a predetermined selection method out of the specific resource.

### (Supplemental Note 11)

An operating system including the scheduling system according to any one of Supplemental Notes 1 to 10.

### (Supplemental Note 12)

A scheduling method comprising:

determining a specific resource that processes a task, in accordance with a first instruction, being included in the task processed by a calculation processing apparatus, which includes a many-core accelerator as a resource and a processor that controls the resource, and reserving the resource.

### (Supplemental Note 13)

A recording medium storing a scheduling program that causes a computer to realize a scheduling function, the function comprising

determining a specific resource that processes a task, in accordance with a first instruction being included in the task processed by a calculation processing apparatus which includes a many-core accelerator as a resource and a processor that controls the resource, and reserving the resource.

The present invention has been described with the aforementioned exemplary embodiments as exemplary examples. However, the present invention is not limited to the aforementioned exemplary embodiments. In other words, various embodiments that can be understood by those skilled in the art may be applied to the present invention, within the scope thereof.

This application claims priority based on Japanese Patent Application No. 2013-107578 filed on May 22, 2013, the disclosure of which is hereby incorporated by reference thereto in its entirety.

### REFERENCE SIGNS LIST

1 Scheduling system
2 Scheduler
3 Server
4 Host processor
5 Many-core accelerator
6 Task
7 Scheduling system
8 Scheduler
9 Management unit
10 Scheduling system
11 Scheduler
12 Task
13 Scheduling system
14 Scheduler
15 Task
16 Server
17 Many-core accelerator
18 Host processor
19 Main memory
20 Accelerator memory
21 Scheduling system
22 Scheduler
23 Task
24 Scheduling system
25 Scheduler
26 Second task scheduler
27 Scheduling system
28 Scheduler
29 Management unit
30 Second task scheduler
31 Calculation processing apparatus
32 CPU
33 Memory
34 Disk
35 Non-volatile recording medium
36 Input apparatus
37 Output apparatus
38 System
39 System
40 Server
41 Processor
42 Processor
43 Processor
44 Processor
45 Task scheduler
46 Server resource management unit
47 Server
48 Host processor
49 Many-core accelerator
50 Main memory
51 Accelerator memory
52 Task scheduler
53 Server resource management unit
54 System
55 System
56 System
57 System
58 System
59 System
60 System
100 Scheduling system
101 Recommended resource amount calculation unit
102 Scheduler
103 Resource allocation determining unit
104 Scheduler
105 Scheduling system

What is claimed is:

1-12. (canceled)

13. A scheduling system comprising:
a scheduler configured to determine a specific resource that processes a task in accordance with a first instruction to be included in the task processed by a calculation processing apparatus which includes a many-core accelerator being resource and a processor controlling the resource and to reserve the resource.

14. The scheduling system according to claim 13, further comprising:
management unit configured to manage usage status of the resource, wherein
the scheduler determines the specific resource by reading the usage status stored in the management unit.

15. The scheduling system according to claim 14, wherein
the task includes a first part processed by the processor, the first instruction, a second part processed by the resource, and a second instruction for releasing the specific resource, and
the scheduler reserves the specific resource in accordance with the first instruction after the processor processes the first part, and releases the specific resource in accordance with the second instruction after the specific resource processes the second part.

16. The scheduling system according to claim 15, wherein
the calculation processing apparatus further includes a memory accessed by the processor and an accelerator memory accessed by the many-core accelerator,
the task includes the first part, the first instruction, a third part for transferring data from the memory to the accelerator memory, the second part, a fourth part for transferring data from the accelerator memory to the memory, and the second instruction, and
the scheduler reserves the specific resource during processing of the first part performed by the processor and processing of the third part performed by the processor in accordance with the first instruction, and releases the specific resource after processing of the fourth part performed by the processor in accordance with the second instruction.

17. The scheduling system according to claim 16, wherein
the scheduler reserves a specific accelerator memory in accordance with the first instruction, reserves the specific resource after processing of the third part performed by the processor, releases the specific resource in accordance with the second instruction after processing of the second part performed by the specific resource, and releases the specific accelerator memory after processing of the fourth part performed by the processor.

18. The scheduling system according to claim 15, wherein
the task further includes a fifth part for directing a process included in the second part to the processor, and
the scheduler determines that the processor performs processing of the fifth part when the specific resource cannot be reserved in the usage status, and determines that the specific resource performs processing of the second part when the specific resource can be determined.

19. The scheduling system according to claim 13, further comprising:
a second task scheduler configured to control an allocation of the task to the calculation processing apparatus, wherein
the scheduler determines the specific resource in accordance with information related to the task notified to the scheduler by the second task scheduler.

20. The scheduling system according to claim 14, wherein
the scheduler transmits a command for reducing the task to the second task scheduler when a load on the resource is greater than a predetermined first threshold value and transmits a command for increasing the task when a load on the resource is smaller than a predetermined second threshold value by referencing the control unit.

21. The scheduling system according to claim 16, further comprising:
recommended resource amount calculation unit configured to calculate a recommended resource amount in accordance with a predetermined resource calculation method on the basis of at least one type of information out of a storage capacity of the accelerator memory reserved by the task issuing the first instruction, a storage capacity originally included in the accelerator memory, a resource amount requested by the task, or a resource amount originally included in the resource in the many-core accelerator and a storage capacity of an area in an unused state in the accelerator memory, wherein
the scheduler reserves a specific resource depending on the recommended resource amount.

22. The scheduling system according to claim 21, further comprising:
resource allocation determining unit configured to select a resource capable of processing the second part in accordance with a predetermined selection method out of the specific resource.

23. A scheduling method comprising:
determining a specific resource that processes a task in accordance with a first instruction to be included in the task processed by a calculation processing apparatus, which includes a many-core accelerator being resource and a processor controlling the resource, and reserving the resource.

24. A recording medium storing a scheduling program that causes a computer to realize a scheduling function, the function comprising:
determining a specific resource that processes a task in accordance with a first instruction to be included in the task processed by a calculation processing apparatus, which includes a many-core accelerator being resource and a processor controlling the resource, and reserving the resource.

25. An operating system that includes the scheduling system according to claim 13.
